(19) United States
(12) Patent Application Publication
(10) Pub. No.: US 2013/0220226 A1
(43) Pub. Date: Aug. 29, 2013

(54) ODOR-FREE REFUSE CONTAINER

(71) Applicant: Nite Ize, Inc., (US)

(72) Inventor: Gary Michael Molzan, Boulder, CO (US)

(73) Assignee: Nite Ize, Inc., Boulder, CO (US)

(21) Appl. No.: 13/780,853

(22) Filed: Feb. 28, 2013

Related U.S. Application Data
(60) Provisional application No. 61/604,364, filed on Feb. 28, 2012.

(51) Int. Cl. A01K 23/00

(52) U.S. Cl. CPC A01K 23/005
USPC 119/161

(57) ABSTRACT

An odor-resistant refuse receiver includes a front and back panel, the front and back panel sewn together to provide an enclosure with an opening at one end, the front and back panel each including an inner liner having an aluminum coating and an outer liner having fabric-like characteristics. The odor-resistant refuse receiver further includes a loop and rubberized twist-tie, the rubberized twist-tie oriented in the loop, the loop located at the opening of the enclosure, the front and back panel foldable at the opening, such that the opening may be closed and the rubberized twist-tie may be folded about the enclosure to hold the enclosure in a closed position.

### CROSS-REFERENCE TO RELATED APPLICATIONS

This Application claims the benefit of Provisional Application No. 61/604,364 filed on Feb. 28, 2012, titled “Odor-Proof Refuse Container,” the entire disclosure of which is hereby incorporated by reference.

### BACKGROUND

Many people own and enjoy many types of domesticated animals, such as dogs. In many areas, especially those with more urban characteristics, owners must pick up the refuse produced by such animals when they are on public property. Such refuse may be very odorous and, therefore, be undesirable for the user to carry.

### SUMMARY

In order to prevent the user from having to smell the animal refuse that they have to carry with them, an odor-proof bag is provided. In one embodiment, an odor-proof bag provides an odor-free way to transport dog refuse from the point of pick-up to an appropriate disposal location. The bag includes added features such as a storage pocket to carry plastic pick-up bags and hand sanitizer. The odor-proof bag may be fastened in a variety of different ways to a person or pack for the purpose of transporting the contents. Although the bag may be attached to a chain, leash, or other apparatus utilized to secure the animal, it need not be in order to maintain its odor-free operation. Attaching an item to the leash or chain may cause difficulty for the user in using the leash and, therefore, may be undesirable. Although in some alternatives the odor-proof bags include a ZIPLOC™-type closure, these types of closures may be disadvantageous since complete closure may be time consuming and difficult.

In one embodiment, an odor-resistant refuse receiver includes a front and back panel, the front and back panel sewn together to provide an enclosure with an opening at one end, the front and back panel each including an inner liner having an aluminum coating and an outer liner having fabric-like characteristics. The odor-resistant refuse receiver further includes a loop and rubberized twist-tie, the rubberized twist-tie oriented in the loop, the loop located at the opening of the enclosure, the front and back panel foldable at the opening, such that the opening may be closed and the rubberized twist-tie may be folded about the enclosure to hold the enclosure in a closed position. Optionally, the inner lining is biaxially-oriented polyethylene terephthalate coated with aluminum. In one option, the outer lining is nylon fabric. Alternatively, a belt loop is oriented on the back panel. Optionally, the odor-resistant refuse receiver includes a first and second loop oriented on a first and second edge of the enclosure, the first and second loop each receiving a carabineer. In one alternative, the inner lining does not degrade and crack after 100 foldings. Optionally, the enclosure blocks the smell of refuse in the enclosure.

In one embodiment, a method of storing refuse includes providing an odor-resistant refuse receiver including a front and back panel, the front and back panel sewn together to provide an enclosure with an opening at one end, the front and back panel each including an inner liner having an aluminum coating and an outer liner having fabric-like characteristics; a loop; a rubberized twist-tie; the rubberized twist-tie oriented in the loop, the loop located at the opening of the enclosure; and the front and back panel foldable at the opening, such that the opening may be closed and the rubberized twist-tie may be folded about the enclosure to hold the enclosure in a closed position. The method further includes placing refuse in the odor-resistant refuse receiver. The method further includes folding the front and back panel in unison in order to close the opening and create a folded closure portion and folding the rubberized twist-tie to secure the folded closure portion. Optionally, the method may be performed with gloved hands.

### BRIEF DESCRIPTION OF THE FIGURES

FIG. 1 shows a front perspective view of one embodiment of an odor-proof bag;

FIG. 2 shows a rear perspective view of the bag of FIG. 1;

FIG. 3 shows the bag of FIG. 1 receiving refuse;

FIG. 4 shows the bag of FIG. 1 folded for closing;

FIG. 5 shows the bag of FIG. 1 in a closed configuration; and

FIG. 6 shows a peel away view of the bag of FIG. 1.

### DETAILED DESCRIPTION

In one embodiment, an odor-proof bag includes a rip-stop nylon outer shell that protects an inner metallic liner from surface abrasion. The bag seals by using a roll-over design secured by a rubber coated twist-tie, such as a Nite Ize® Gear Tie®. This roll-over closure can be completed quickly, easily, and reliably by the user and, therefore, is favorable over other closure methods. The opening and closing, therefore, requires little effort and can be performed while wearing gloves or in limited illumination conditions. The geartie or rubberized twist-tie is easily removed or replaced from the nylon webbing that holds it in place. The compact design makes it easy to fold and store in a pocket or pack-ready for use when and if the need arises. The bag is lightweight, so there is no reason not to carry it on every outing. Trail runners and day hikers will appreciate this feature.

In one embodiment, the metallic fabric liner does not retain odors and wipes clean should the need arise. The entire bag is washable. The metallic fabric blocks the radiant energy from the sun, so the bag contents do not “cook” on a hot summer day. Optionally the bag includes three webbing loops as attachment points for two (included) Nite Ize® S-Biners®. These are double-gated carabineers. This provides additional methods of connecting the odor-resistant refuse receiver to a waistband, backpack, dog leash, etc.

In one embodiment, the bag includes a metallic fabric liner. Optionally, this is a multi-laminated “space blanket” material. Alternatively, it is an aluminized material used to line refrigerators composed of biaxially-oriented polyethylene terephthalate material coated with aluminum. The biaxially-oriented polyethylene terephthalate (sometimes know as Mylar™) material coated with aluminum both wears well and blocks out odors. Those skilled in the art would not readily look to aluminum-coated materials because, although they may block out smell, these materials tend to crack and break down quickly. Other aluminum materials tested cracked quickly when the fabric was folded, which in combination with the desired closing methodology would lead to a failure of the product. Therefore, a process of depositing vaporized aluminum to yield the aluminum-coated Mylar™ enhances the operation of the bag significantly.

The construction of the bag enables its odor-proof nature at least in part. The combination of the metallic fabric with the outer nylon fabric makes this a sewn product capable of being odor-proof. The sewn seams undergo some stress when the bag is full. Without the added nylon fabric layer, the metallic fabric layer would stretch along the needle holes and leak odors.

Additionally, embodiments of the bag provide a unique closure and unique secondary attachment mechanisms.

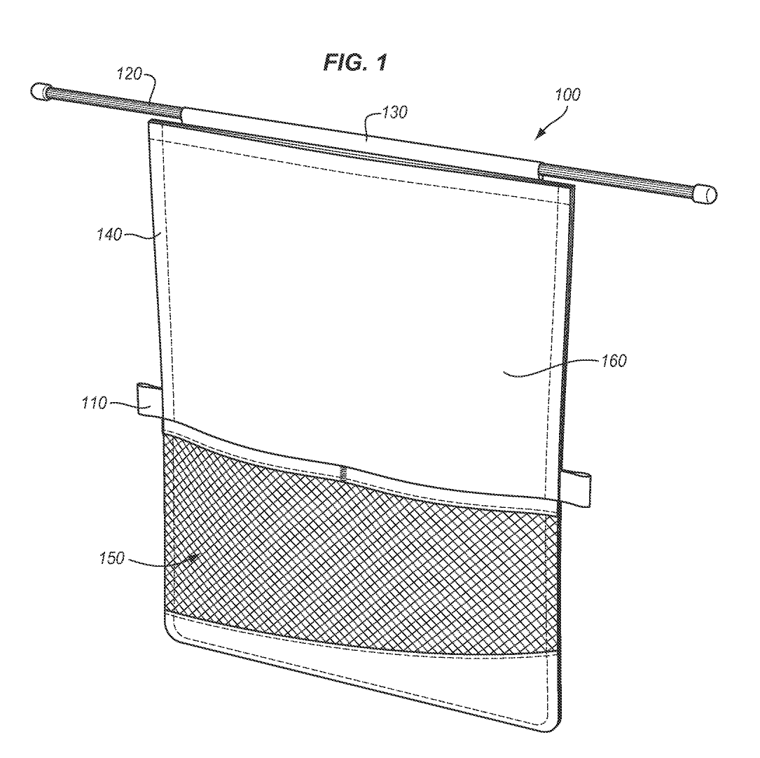

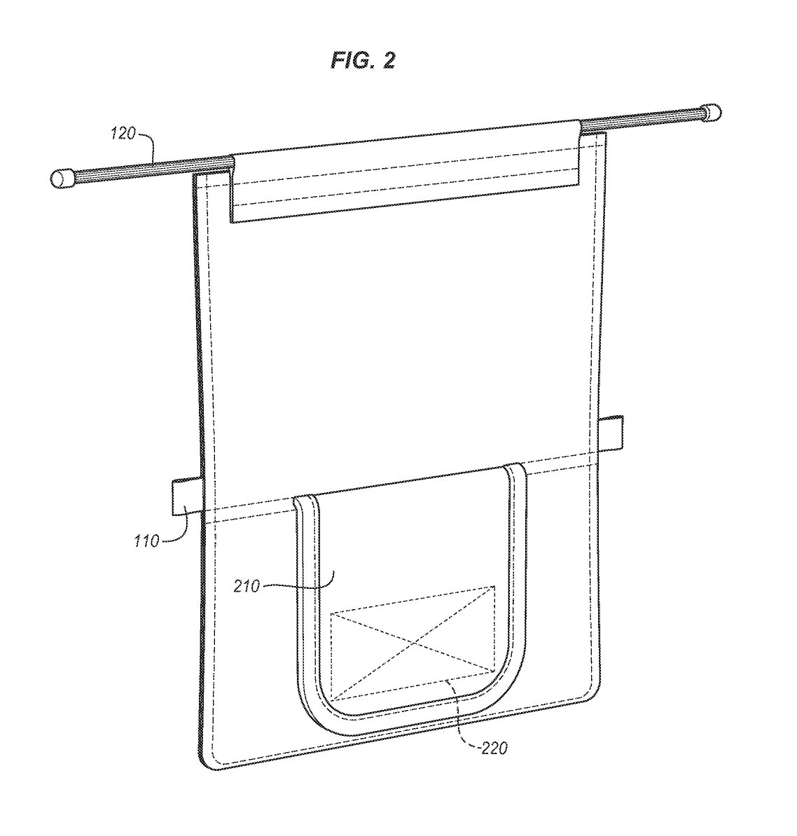

FIG. 1 shows one embodiment of an odor-resistant bag. Bag 100 includes attachment loops 110 and closure mechanism 120, oriented in receiving loop 130. Closure mechanism 120 is a rubberized twist-tie. In some embodiments, this is a Gear Tie® offered by Nite Ize®. Bag portion 160 is defined by sewn seams 140 and includes receiving pouch 150. FIG. 2 shows a rear view of bag 100 and includes belt closure strap 210. Belt closure strap 210 is releasable from Velcro™ holder 220.

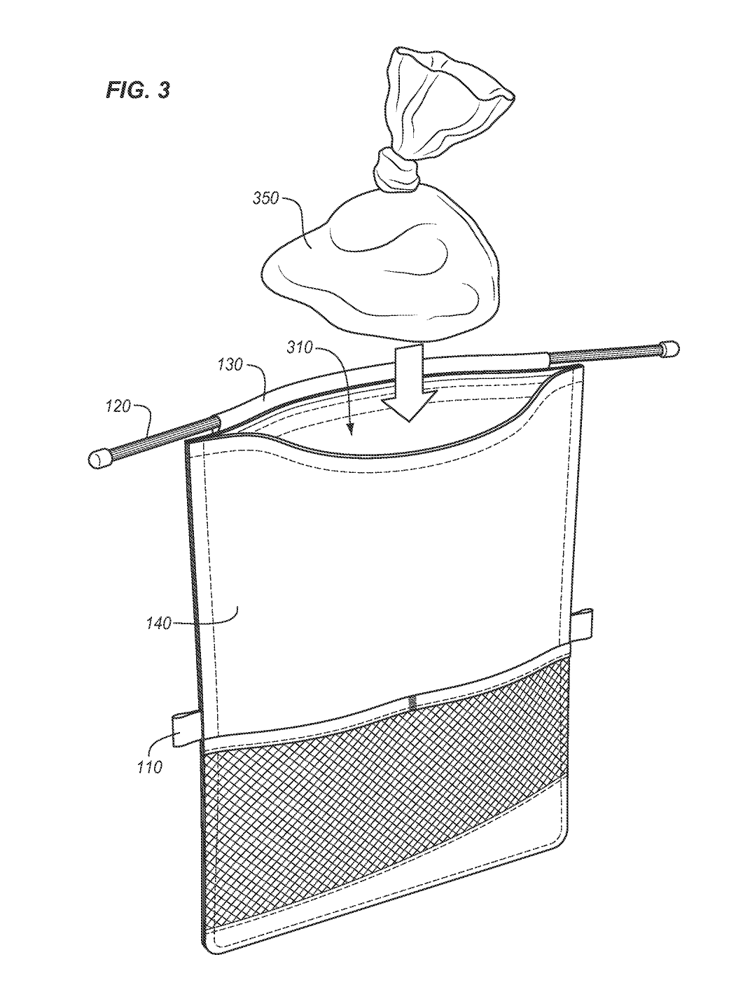

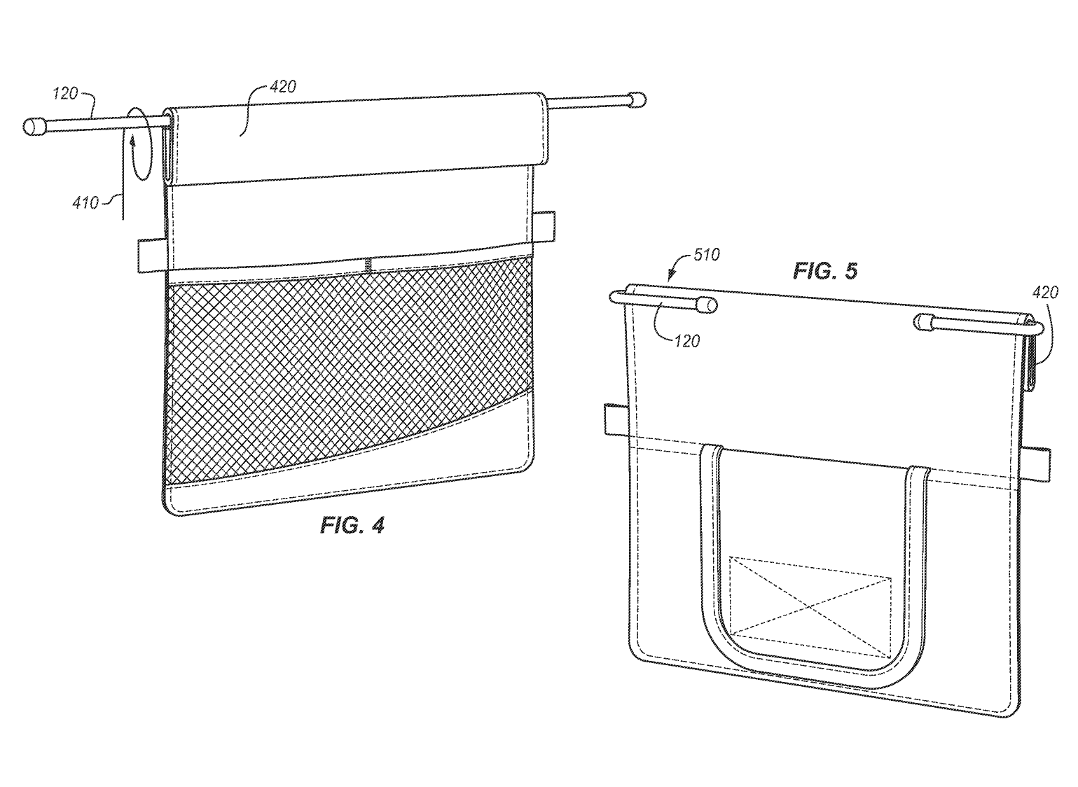

FIG. 3 shows bag opening 310 for receiving refuse 350. FIGS. 4 and 5 show the closure methodology for bag 100. The top portion of the bag is folded according to the motion shown by arrow 410, to create folded seal portion 420. Closure mechanisms 120 are then folded as shown at fold 510. This seals the bag and the smell inside. This closure mechanism has the advantage of being easily executed by the user and is compatible and may be executed by a user wearing gloves or other items on their hands. This is advantageously combined with the odor-resistant aluminum-coated material. As noted above, ordinary materials would not provide the durability to withstand the folding closure. This complementary combination of materials and foldable closure has been difficult to determine

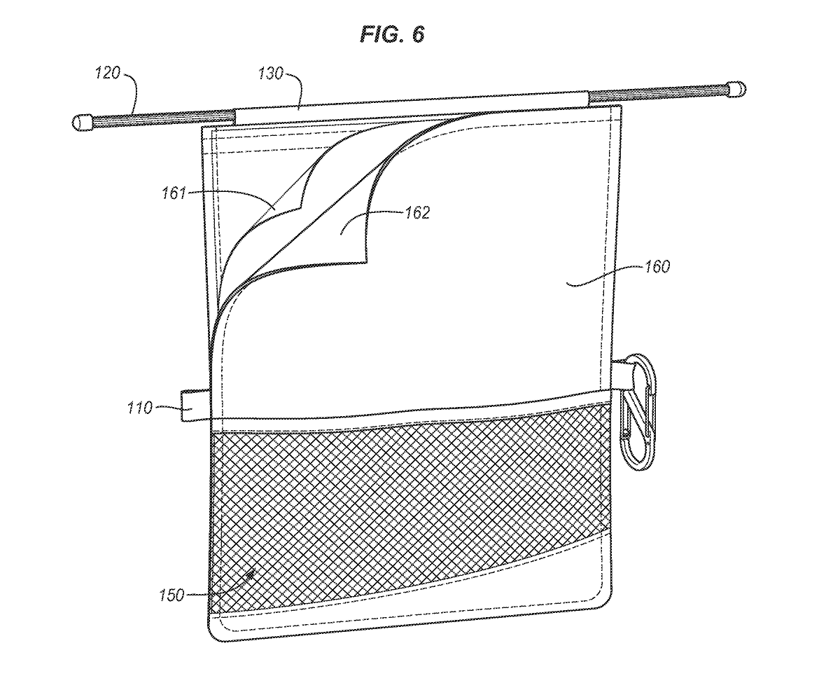

FIG. 6 shows the composition of the bag 100. It includes an inner layer 161 of aluminum-coated material and an outer layer 162 of durable material such as nylon. FIG. 6 also shows an S-Biner® oriented in attachment loop 110. Various carabineers or other items may be utilized in these attachment loops.

In alternative embodiments, the bag 100 may be sized and configured to be used as a refuse container for a car. In this case the refuse container may have additional attachment mechanisms oriented on the bag, including but not limited to straps and additional rubber twist ties (gear ties). Using these attachment mechanisms, the bag may be attached to the seat, vent, or other area within the vehicle and then operated as described above. Optionally, the bag may also be configured to be used a diaper bag. Various sizing and the attachment of additional attachment mechanisms are possible. Optionally, the additional attachment mechanisms may be oriented in the attachment loops 110, including rubber twist ties or straps.

The previous detailed description is of a small number of embodiments for implementing the systems and methods for creating odor proof bags and the systems of odor proof bags and is not intended to be limiting in scope. The following claims set forth a number of the embodiments of the systems and methods for creating odor proof bags and the systems of odor proof bags disclosed with greater particularity.

I claim:

1. An odor-resistant refuse receiver, comprising:
a front and back panel, the front and back panel sewn together to provide an enclosure with an opening at one end, the front and back panel each including an inner liner having an aluminum coating and an outer liner having fabric-like characteristics;
a loop; and
a rubberized twist-tie, the rubberized twist-tie oriented in the loop, the loop located at the opening of the enclosure, the front and back panel foldable at the opening, such that the opening may be closed and the rubberized twist-tie may be folded about the enclosure to hold the enclosure in a closed position.

2. The odor-resistant refuse receiver of claim 1 wherein the inner lining is biaxially-oriented polyethylene terephthalate coated with aluminum.

3. The odor-resistant refuse receiver of claim 2 wherein the outer lining is nylon fabric.

4. The odor-resistant refuse receiver of claim 3, further comprising a belt loop oriented on the back panel.

5. The odor-resistant refuse receiver of claim 4, further comprising a first and second loop oriented on a first and second edge of the enclosure, the first and second loop each receiving a carabineer.

6. The odor-resistant refuse receiver of claim 3 wherein the inner lining does not degrade and crack after 100 foldings.

7. The odor-resistant refuse receiver of claim 1 wherein the enclosure blocks the smell of refuse in the enclosure.

8. A method of storing refuse, the method comprising:
providing an odor-resistant refuse receiver including a front and back panel, the front and back panel sewn together to provide an enclosure with an opening at one end, the front and back panel each including an inner liner having an aluminum coating and an outer liner having fabric-like characteristics;
a loop;
a rubberized twist-tie, the rubberized twist-tie oriented in the loop, the loop located at the opening of the enclosure, the front and back panel foldable at the opening, such that the opening may be closed and the rubberized twist-tie may be folded about the enclosure to hold the enclosure in a closed position;
placing refuse in the odor-resistant refuse receiver;
folding the front and back panel in unison in order to close the opening and create a folded closure portion; and
folding the rubberized twist-tie to secure the folded closure portion.
